(19) United States
(12) Patent Application Publication
(10) Pub. No.: US 2009/0229954 A1
(43) Pub. Date: Sep. 17, 2009

(54) SPECIMEN TRANSPORT SYSTEM

(75) Inventors: Kazuhiro NODA, Hitachinaka (JP); Terumi Tamura, Hitachinaka (JP); Jyunichi Ooizumi, Kasumigaura (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/357,674

(22) Filed: Jan. 22, 2009

(30) Foreign Application Priority Data
Mar. 11, 2008 (JP) 2008-061244

(51) Int. Cl. B65G 21/14; B65G 23/44

(52) U.S. Cl. 198/812; 198/813

(57) ABSTRACT

An object of the present invention is to provide a specimen transport system that can easily be installed without requiring much time and regardless of various transport distances and also is inexpensive. In the present invention, the distance between apparatuses, which had been difficult to be met by a specimen transport line when a specimen transport system is built, can easily be met by providing a structure in which a conveyor belt is formed in an endless loop and the shape of the loop of the conveyor belt is changed according to the length of a rack transport surface (rack transport surface length), and flexibility for apparatus and system installation and space efficiency can be enhanced, enabling substantial reduction of time and costs in building a specimen transport system.

### BACKGROUND OF THE INVENTION

1. Field of the Invention

The present invention relates to a specimen transport system, and specifically relates to a specimen transport system used to, when specimens, such as blood or urine, collected from patients in a hospital or the like are tested in a laboratory in the clinical test field, automatically transport the specimens to a specimen pretreatment apparatus or a specimen analysis apparatus.

2. Background Art

A specimen transport system refers to a system that connects apparatuses, such as a specimen pretreatment apparatus and a specimen analysis apparatus, via a specimen transport line to provide automatic transportation between the apparatuses.

Pretreatment apparatuses and analysis apparatuses are installed in various types of locations and in various manners because the room size and the positions of columns and pipes are different depending on the facility to which such apparatuses are delivered. Therefore, a specimen transport system is build in conformity with the transport distance between the apparatuses, which is different depending on the facility to which the system is delivered. For conventional specimen transport systems, for example, JP Published Patent Application No. 2001-99845 A and JP Published Patent Application No. 11-83864 A (1999) describe line height adjustment, and building of a system.

### SUMMARY OF THE INVENTION

For conventional specimen transport systems, there are several types of specimen transport lines having fixed lengths (e.g., 600 mm, 900 mm and 1200 mm), and a specimen transport system is built by combining some types of specimen transport lines in conformity with the installation locations of the apparatuses and the configuration of the system in the facility, to which the system is delivered, so that the system can be adapted to various transport distances.

However, a transport distance that cannot be met by a mere combination of those various types of specimen transport lines may occur. For example, there may be a case where the line does not reach the apparatuses because it is shorter than the transport distance between the apparatuses required when building a specimen transport system by several tens of millimeters.

The present techniques and means counter such problem by re-installing the apparatuses so as to adapt the transport distance to the length of the line, or designing and manufacturing a new specimen transport line that can be adapted to the transport distance. As a result, problems have arisen in, e.g., requiring a long time for such re-installing or designing and manufacturing and also requiring high costs.

In view of the aforementioned problems, an object of the present invention is to provide a specimen transport system that can easily be installed regardless of various transport distances, and is also inexpensive.

The present invention provides a specimen transport system comprising: a transport line including a rack transport surface that transports a transport rack that holds a specimen container including a specimen such as blood or urine; and a conveyor belt included in the transport line, wherein the conveyor belt is formed in an endless loop, and the shape of the loop of the conveyor belt is changed according to a length of the rack transport surface (rack transport surface length).

According to the present invention, e.g., various transport distances between apparatuses can be met by changing the length of a rack transport surface (rack transport surface length) of a conveyor belt.

### BRIEF DESCRIPTION OF THE DRAWINGS

FIG. 1 is an illustrative drawing of a specimen transport line according to an embodiment of the present invention, characterized by having a structure in which the amount of movement of an extra-length adjustment pulley and the amount of change in the rack transport surface length of a conveyor belt are substantially equal to each other.

FIG. 2 is an illustrative drawing of a specimen transport line according to another embodiment of the present invention, characterized by having a structure in which tension adjustment and change of the rack transport surface length of a conveyor belt can be made simultaneously.

FIG. 3 is an illustrative drawing of a specimen transport line according to another embodiment of the present invention, characterized by having a structure in which a large amount of change in the rack transport surface length of a conveyor belt can be provided by means of multiple extra-length adjustment pulleys.

FIG. 4 is an illustrative drawing of a specimen transport line according to another embodiment of the present invention, characterized by having a structure in which an extra-length adjustment pulley can make adjustment in a height direction.

FIG. 5 is a cross-sectional view taken along line A-A of FIG. 2 according to another embodiment of the present invention.

FIG. 6 is a diagram illustrating support guide rollers according to another embodiment of the present invention.

FIG. 7 is a diagram illustrating a support guide according to another embodiment of the present invention.

### DESCRIPTION OF SYMBOLS

1 specimen transport rack
2 belt
3, 6, 8, 10, 16 and 17 belt supporting pulley
4 motor
5 drive shaft pulley (belt supporting pulley)
7 tension adjustment pulley
9, 11, 12, 13, 14 and 15 extra-length adjustment pulley
18 tension and extra-length adjustment pulley
19 rack transport surface length of a conveyor belt

### DETAILED DESCRIPTION OF THE PREFERRED EMBODIMENTS

A specimen transport line in a specimen transport system according to the present invention transports racks that hold specimen containers including biological samples, which are specimens to be tested such as blood or urine. Examples of these transport racks include a transport rack in which only one specimen container including a biological sample is placed and a transport rack in which, e.g., five or ten specimens are placed.

Embodiments of the present invention characterized in that the length of a rack transport surface (rack transport surface length) of a conveyor belt included in a specimen transport line is changed will be described with reference to the accompanying drawings.

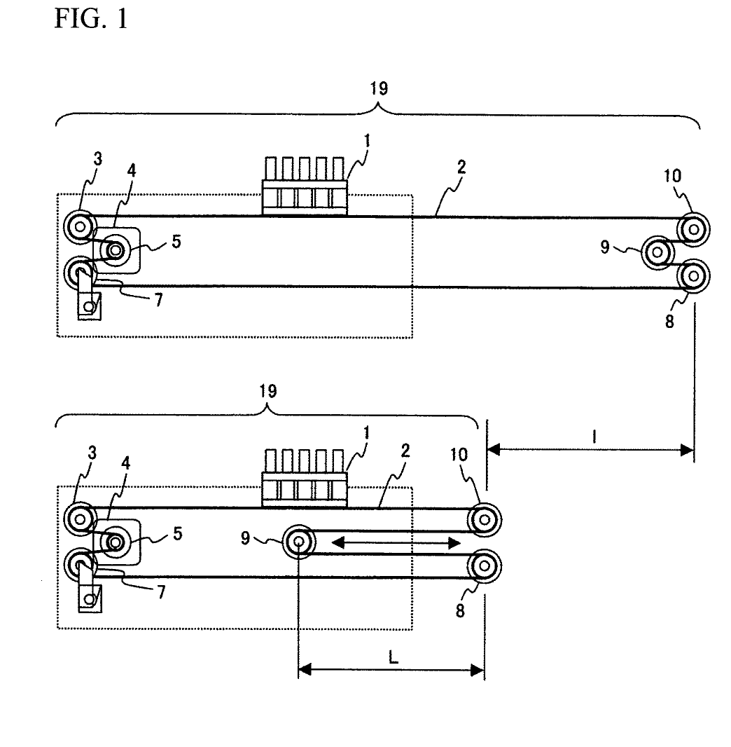

FIGS. 1, 2, 3 and 4 are drawings illustrating an embodiment of a specimen transport line included in a specimen transport system according to the present invention, the specimen transport line having a structure in which the rack transport surface length of a conveyor belt formed in an endless loop can be changed.

Regarding an embodiment shown in FIG. 1, an overview of the configuration and operation of the specimen transport line will be described.

FIG. 1 is an illustrative diagram of a specimen transport line characterized in having a structure in which the length L of movement of an extra-length adjustment pulley 9 and the length 1 of change in the rack transport surface length 19 of a conveyor belt 2 are substantially equal to each other (L=1).

A force generated by a motor 4 is conveyed by a drive shaft pulley 5 to the conveyor belt 2 supported by belt supporting pulleys 3, 6, 8 and 10. The rack transport surface length 19 of the conveyor belt 2 is changed by moving the belt supporting pulleys 8 and 10 laterally.

However, when the belt supporting pulleys 8 and 10 are moved laterally to change the rack transport surface length 19 of the conveyor belt 2, the tension of the conveyor belt 2 greatly changes, causing an extra length, and thus goes beyond the range of the tension that can be adjusted by a belt tension adjustment pulley 7. In order to transport racks, it is necessary to maintain the tension of the conveyor belt 2 constant.

Therefore, a structure in which an extra length of the rack transport surface length 19 of the conveyor belt 2 can be adjusted using the extra-length adjustment pulley 9 that make adjustment of the rack transport surface length 19 of the conveyor belt 2 and the tension of the belt 2 can be adjusted by the belt tension adjustment pulley 7 is used.

In the structure shown in FIG. 1, when the rack transport surface length 19 of the conveyor belt 2 is changed, the length 1 of change in the rack transport surface length 19 and the length L of movement of the extra-length adjustment pulley 9 are substantially equal to each other (1=L).

Therefore, the tension of the conveyor belt 2 can easily be made to fall within the range of tension that can easily be adjusted by the tension adjustment pulley 7 by changing the length L of movement of the extra-length adjustment pulley 9 by the length 1 of the rack transport surface length 19 of the conveyor belt 2.

As described above, the conveyor belt included in the transport line is formed in an endless loop, and the shape of the loop can be changed according to the length of the transport line, and accordingly, the transport line can easily be installed because the length can easily be adjusted regardless of various transport distances between the apparatuses such as an automatic analysis apparatus.

Also, the transport system is inexpensive because it has a configuration in which the conveyor belt is formed in an endless loop and the shape of the loop is changed according to the transport line. As well as the flexibility for apparatus and system installation, the space efficiency is enhanced, enabling substantial reduction of time and costs in building a specimen transport system. Also, a structure in which the rack transport surface length of a conveyor belt is changed can be applied to an analysis apparatus or a pretreatment apparatus.

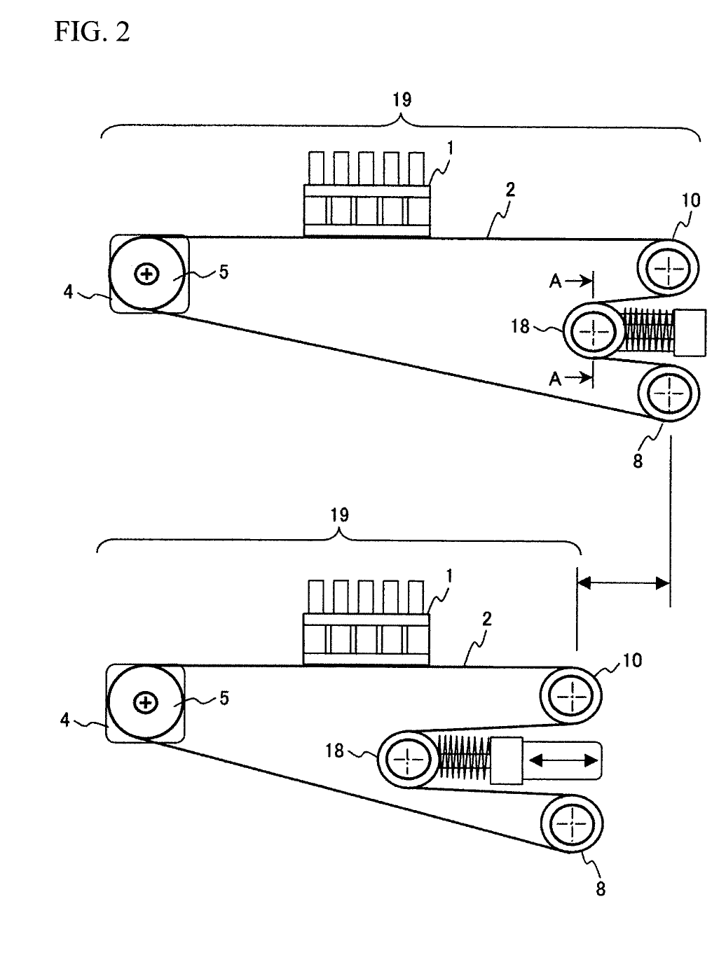

Next, regarding an embodiment shown in FIG. 2, an overview of the configuration and operation of a specimen transport line will be described.

FIG. 2 is an illustrative diagram of a specimen transport line characterized by having a structure in which when the rack transport surface length 19 of a conveyor belt 2 is changed, tension adjustment and extra-length adjustment can simultaneously be made.

In FIG. 1, an extra-length adjustment pulley 9 and a tension adjustment pulley 7 are provided at different positions, and therefore, when the rack transport surface length 19 of the conveyor belt 2 is changed, it is necessary to adjust the tension of the conveyor belt 2 by means of the tension adjustment pulley 7 after adjusting the extra-length of the conveyor belt 2 by means of the extra-length adjustment pulley 9.

Accordingly, when the rack transport surface length 19 of the conveyor belt 2 is changed, the conveyor belt 2 may come off from the pulleys.

The embodiment shown in FIG. 2 provides a structure in which tension adjustment function and extra-length adjustment can be made simultaneously by means of a tension and extra-length adjustment pulley 18, which is a pulley having both of the two functions, i.e., the tension adjustment function and the extra-length adjustment function which the extra-length adjustment pulley 9 in FIG. 1 and the tension adjustment pulley 7 in FIG. 1 have.

As a result, when the rack transport surface length 19 of the conveyor belt 2 is changed, the conveyor belt 2 can be prevented from coming off from the pulleys, enabling the rack transport surface length 19 of the conveyor belt 2 to be changed while the tension of the conveyor belt 2 is checked.

Also, since tension adjustment and extra-length adjustment are made simultaneously by means of the tension and extra-length adjustment pulley 18, the rack transport surface length 19 of the conveyor belt 2 can be changed while the conveyor belt is maintained tightly, which is effective for, e.g., adjustment for a very small length.

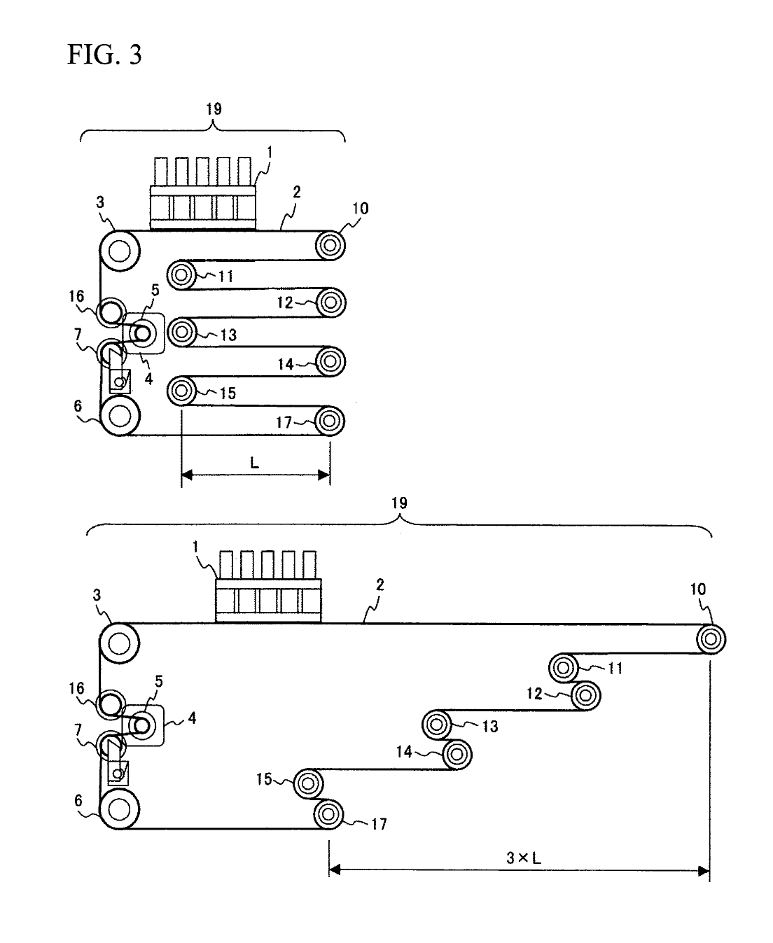

Next, regarding an embodiment illustrated in FIG. 3, an overview of the configuration and operation of a specimen transport line will be described.

FIG. 3 is an illustrative diagram of a specimen transport line characterized by having a structure in which use of multiple extra-length adjustment pulleys 11, 12, 13, 14 and 15 enables provision of a large amount of change in the rack transport surface length 19 of the conveyor belt 2.

In the case of FIG. 3, a structure in which the conveyor belt 2 is folded back three times with a width of L using five extra-length adjustment pulleys enables the rack transport surface length 19 of the conveyor belt 2 to be changed by a maximum of approximately 3 L. Accordingly, when the transport distance between the apparatuses includes a relatively-large gap due to problems of the system configuration, the rack transport surface length 19 of the conveyor belt 2 can easily be adapted to the transport distance.

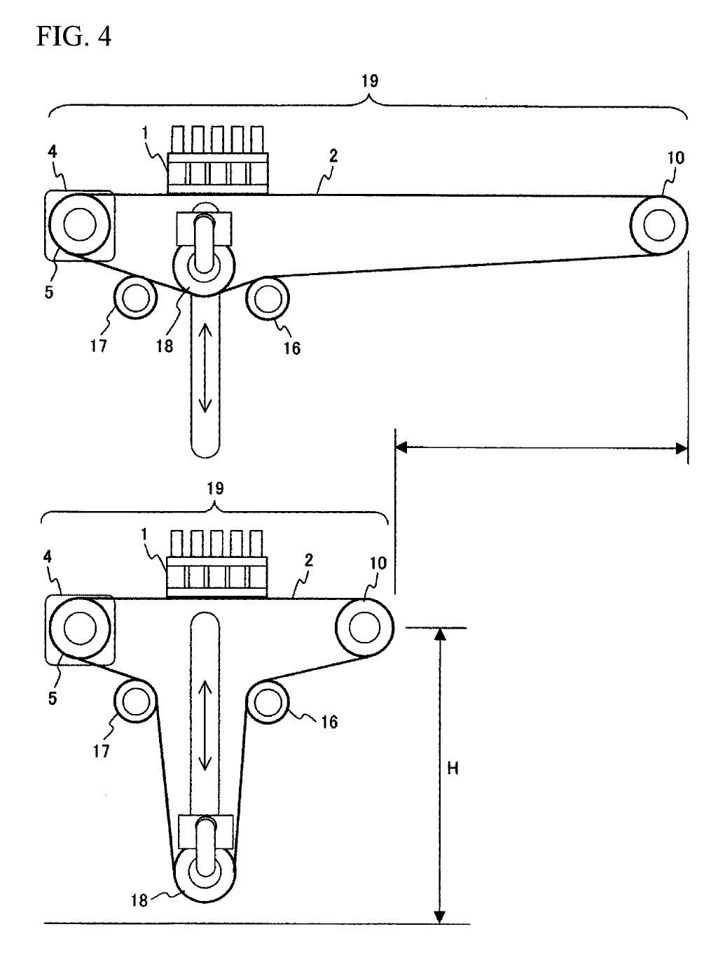

Next, regarding an embodiment shown in FIG. 4, an overview of the configuration and operation of a specimen transport line will be described.

FIG. 4 is an illustrative diagram of a specimen transport line characterized by having a structure in which a tension and extra-length adjustment pulley 18 having both of two functions, i.e., a tension adjustment function and an extra-length function, makes adjustment in the height direction.

The embodiment shown in FIG. 4 is effective for the case where a sufficient height H up to the transport surface can be secured for the amount of change in the length 19 of a conveyor belt 2.

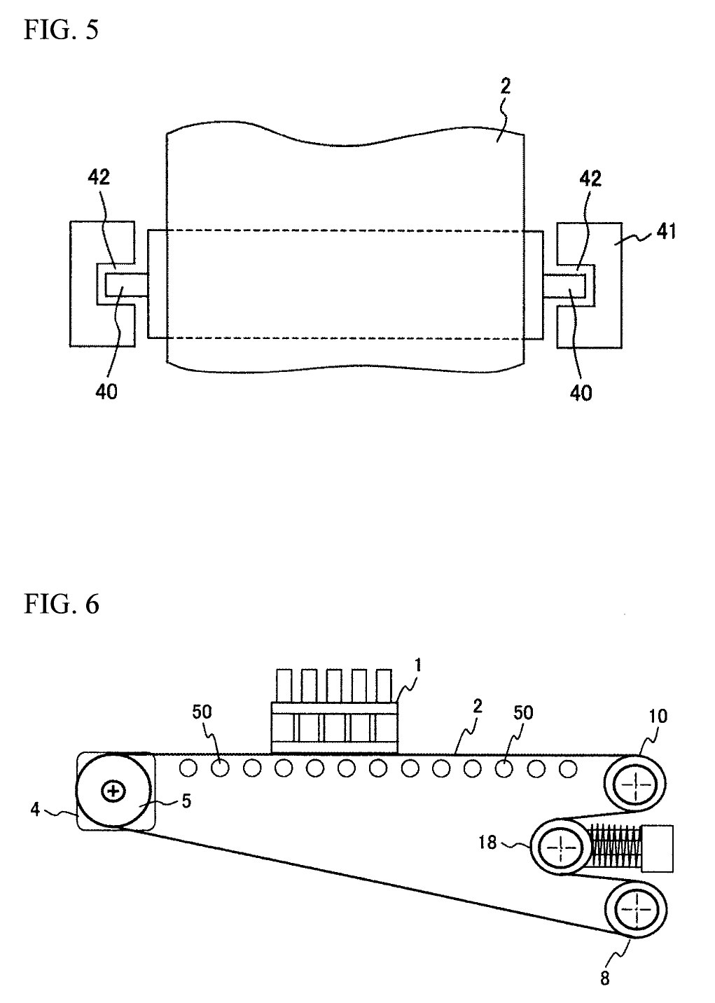

Next, a slidable supporting structure illustrated in FIG. 5 will be described.

A spindle 40 of a tension and extra-length adjustment pulley 18 is slidably supported by slide grooves 42 of rib members 41 provided to a frame of a specimen transport system. The tension and extra-length adjustment pulley 18 is fixed at a position where the tension of the conveyor belt 2 is adjusted to a proper value, so that it cannot slide. Since the tension and extra-length adjustment pulley 18 is slidably supported by the slide grooves 42, the tension can easily be adjusted.

The slide grooves 42 can be oriented in a direction other than the longitudinal direction shown in FIG. 4 and the lateral direction shown in FIG. 2.

An embodiment illustrated in FIG. 6 will be described.

This embodiment is characterized by including support guide rollers 50 that support a conveyor belt 2 between two belt supporting pulleys 5 and 10 from the lower side. As a result of supporting the conveyor belt 2 by means of the multiple support guide rollers 50 from the lower side, flexure of the conveyor belt 2 can be prevented, and thus, transport racks can be transported in a stable manner.

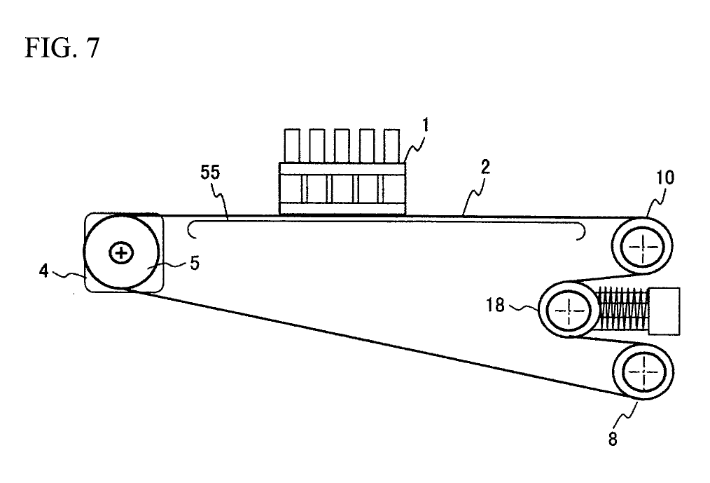

An embodiment illustrated in FIG. 7 will be described.

This embodiment is characterized by including a support guide 55 that supports a conveyor belt 2 between two belt supporting pulleys 5 and 10 from the lower side. As a result of supporting the conveyor belt 2 from the lower side by means of the support guide with both ends rounded, flexure of the conveyor belt 2 is prevented, and thus, transport racks can be transported in a stable manner.

What is claimed is:

1. A specimen transport system comprising: a transport line including a rack transport surface that transports a transport rack that holds a specimen container including a specimen such as blood or urine; and a conveyor belt included in the transport line, wherein
the conveyor belt is formed in an endless loop, and the shape of the loop of the conveyor belt is changed according to a length of the rack transport surface (rack transport surface length).

2. The specimen transport system according to claim 1, further comprising at least two belt supporting pulleys that support both ends of the rack transport surface of the conveyor belt and determine a length of the transport line, wherein
the rack transport surface length is changed by changing a distance between the two belt supporting pulleys.

3. The specimen transport system according to claim 1, further comprising an extra-length adjustment pulley that adjusts an extra length of the conveyor belt, the extra length varying depending on the rack transport surface length.

4. The specimen transport system according to claim 1, further comprising a drive shaft pulley that applies a transport movement force to the conveyor belt.

5. The specimen transport line according to claim 4, further comprising a tension adjustment pulley that adjusts a tension of the conveyor belt against the drive shaft pulley.

6. The specimen transport line according to claim 1, wherein one pulley is used as both of an extra-length adjustment pulley that adjusts an extra length of the conveyor belt, the extra length varying depending on the rack transport surface length, and a tension adjustment pulley that adjusts a tension of the conveyor belt against the drive shaft pulley.

7. The specimen transport line according to claim 2, wherein at least one of the two belt supporting pulleys doubles as a drive shaft pulley that applies a transport movement force to the conveyor belt.

8. The specimen transport line according to claim 2, further comprising a support guide roller or a support guide that supports the conveyor belt from a lower side, between the two belt supporting pulleys.

9. The specimen transport line according to claim 3, wherein the extra-length adjustment pulley, the tension adjustment pulley or the pulley used as both of the extra-length adjustment pulley and the tension adjustment pulley is slidable relative to a guide groove that moves in a direction in which the tension of the conveyor belt is changed.

10. The specimen transport line according to claim 5, wherein the extra-length adjustment pulley, the tension adjustment pulley or the pulley used as both of the extra-length adjustment pulley and the tension adjustment pulley is slidable relative to a guide groove that moves in a direction in which the tension of the conveyor belt is changed.

11. The specimen transport line according to claim 6, wherein the extra-length adjustment pulley, the tension adjustment pulley or the pulley used as both of the extra-length adjustment pulley and the tension adjustment pulley is slidable relative to a guide groove that moves in a direction in which the tension of the conveyor belt is changed.

12. The specimen transport line according to claim 7, wherein the extra-length adjustment pulley, the tension adjustment pulley or the pulley used as both of the extra-length adjustment pulley and the tension adjustment pulley is slidable relative to a guide groove that moves in a direction in which the tension of the conveyor belt is changed.
